(19) United States
(12) Patent Application Publication
(10) Pub. No.: US 2024/0173200 A1
(43) Pub. Date: May 30, 2024

(54) COSMETIC APPLICATOR

(71) Applicant: LIBO COSMETICS CO., LTD., Taichung (TW)

(72) Inventor: HSIAO-YUN LIN, Taichung (TW)

(21) Appl. No.: 18/071,455

(22) Filed: Nov. 29, 2022

(51) Int. Cl. A61H 15/00; A45D 34/04

(52) U.S. Cl. CPC A61H 15/0092; A45D 34/041; A61H 2015/0042; A61H 2201/105; A61H 2201/1695

(57) ABSTRACT

A cosmetic applicator includes a shaft, a ball and at least one bead. The shaft includes a slender section, an enlarged section formed at an end of the slender section, a socket formed at an end of the enlarged section, and a boss extending from an internal face of the socket. The ball includes a front portion extending from the socket and a rear portion rotationally inserted in the socket and abutted against the boss. The at least one bead is rotationally extending around the slender section of the shaft.

### BACKGROUND OF INVENTION

### 1. Field of Invention

The present invention relates to cosmetics and, more particularly, to a cosmetic applicator.

### 2. Related Prior Art

Chinese Patent CN101869386 discloses a cosmetic applicator including a rod 6, an applicating section 7 formed at an end of the rod 6, and a handle/cap 8 connected to an opposite end of the rod 6. The applicating section 7 includes three balls 15, 20 and 21 made of a same material in different sizes. The handle/cap 8 is operable to insert the rod 6 in the container 3, thereby bringing the applicating section 7 into contact with cosmetics in the container 3. Then, the handle/cap 8 is operable to move the applicating section 7 from the container 3. Now, the applicating section 7 carries some of the cosmetics. Then, the hand/cap 8 is operable to bring the applicating section 7 into contact with a user's skin to applicate some of the cosmetics on the user's skin. However, the cosmetic applicator is only operable to applicate the cosmetics on the user's skin because the balls 15, 20 and 21 are not rotatable relative to the rod 6.

The present invention is therefore intended to obviate or at least alleviate the problems encountered in the prior art.

### SUMMARY OF INVENTION

It is the primary objective of the present invention to provide a cosmetic applicator operable for massage in addition to application of cosmetics.

To achieve the foregoing objective, the cosmetic applicator includes a shaft, a ball and at least one bead. The shaft includes a slender section, an enlarged section formed at an end of the slender section, a socket formed at an end of the enlarged section, and a boss extending from an internal face of the socket. The ball includes a front portion extending from the socket and a rear portion rotationally inserted in the socket and abutted against the boss. The at least one bead is rotationally extending around the slender section of the shaft.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a top view of a cosmetic applicator according to the preferred embodiment of the present invention;

FIG. 2 is an exploded view of the cosmetic applicator shown in FIG. 1;

FIG. 3 is exploded view of an applicating unit of the cosmetic applicator shown in FIG. 2;

FIG. 4 is a cut-away view of the applicating unit shown in FIG. 3; and

FIG. 5 is a cross-sectional view of an applicating unit of the cosmetic applicator shown in FIG. 3.

### DETAILED DESCRIPTION OF PREFERRED EMBODIMENT

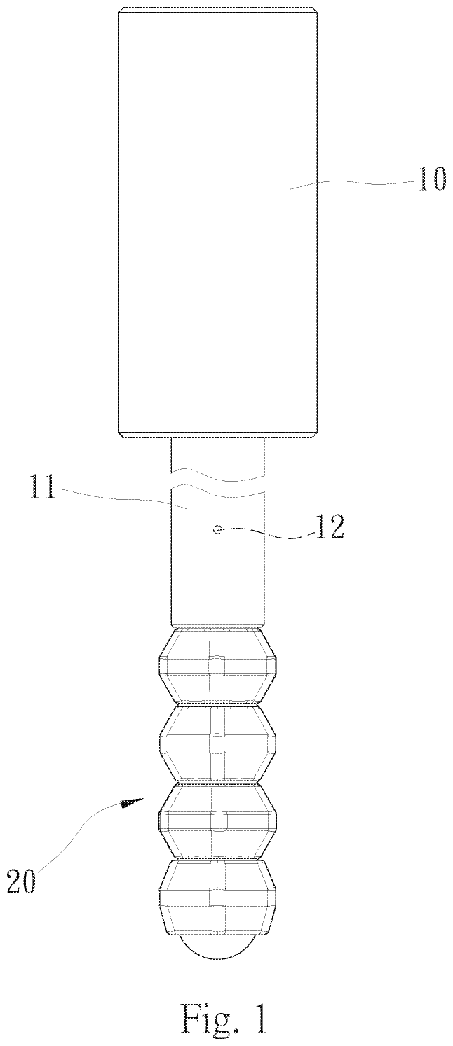

Referring to FIG. 1, a cosmetic applicator includes a handle/cap 10, a shank 11 and an applicating unit 20 according to the preferred embodiment of the present invention. The handle/cap 10 is connected to a front end of the shank 11. The applicating unit 20 is connected to a rear end of the shank 11.

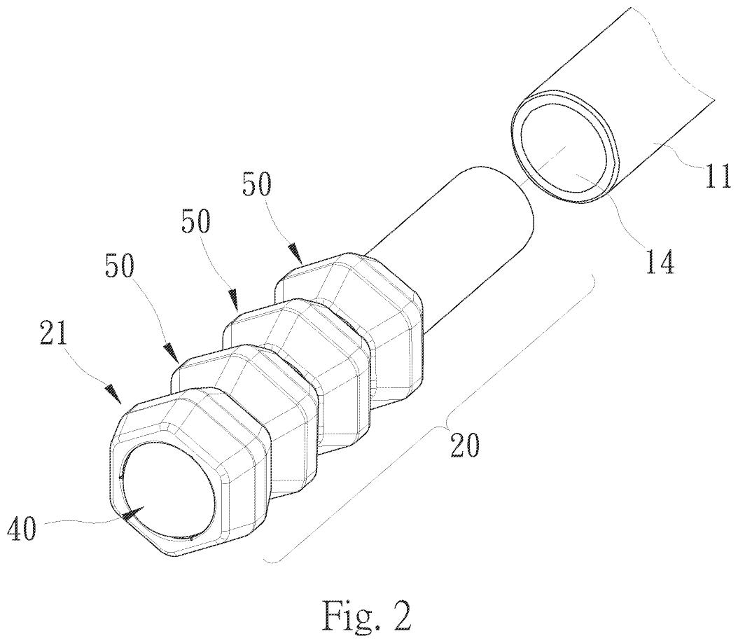

Referring to FIG. 2, the includes applicating unit 20 includes a shaft 21, a front massaging unit 40 and three peripheral massaging unit 50. The massaging elements 40 and 50 are rotatable relative to the shaft 21.

A rear section of the shaft 21 is inserted in a bore 14 made in the front end of the shank 11. A connecting device 12 is used to secure the shaft 21 to the shank 11. Preferably, the connecting device 12 is a boss extending from an internal face of the shank 11. The connecting device 12 is made by punching an external face of the shank 11. The connecting device 12 abuts against the shaft 21.

In another embodiment, the connecting device 12 includes a pin inserted in the shaft 21 and the shank 11, thereby securing the shaft 21 to the shank 11.

In another embodiment, the connecting device 12 includes two threads. One of the threads is formed on the shaft 21. The other one of the threads is formed on an internal face of the shank 11, i.e., a wall of the bore 14. The threads are engaged with each other, thereby securing the shaft 21 to the shank 11.

In another embodiment, the connecting device 12 includes a conical rear section of the shaft 21 and a conical bore 14 in the shank 11. The conical rear section of the shaft 21 is fitted in the conical bore 14 of the shank 11 by force, thereby securing the shaft 21 to the shank 11. Reference is made to Chinese Patent CN101869386 for details of such connecting device 12.

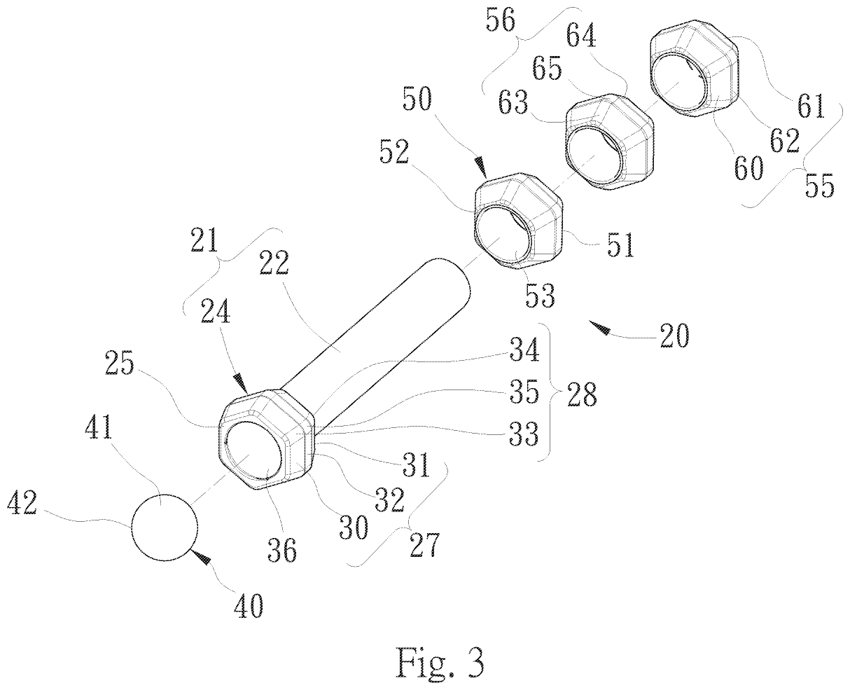

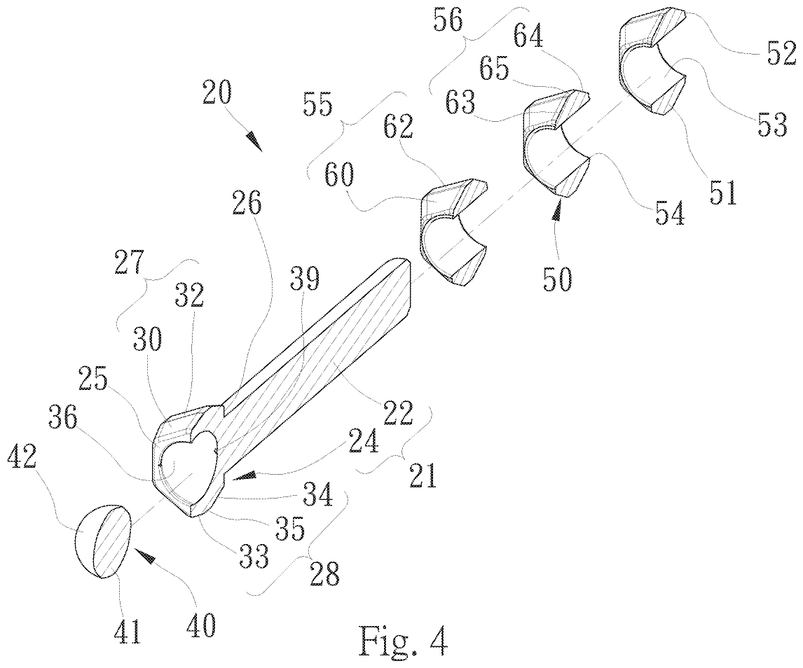

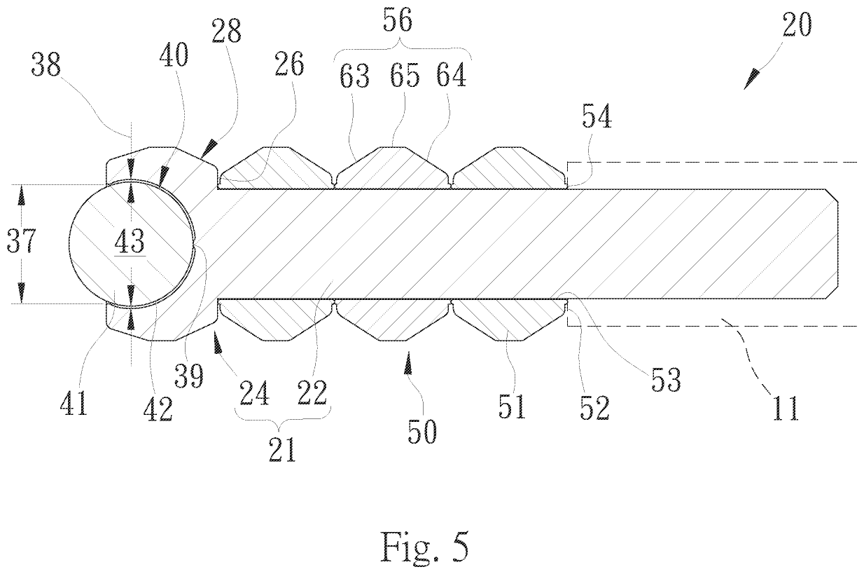

Referring to FIG. 3, the shaft 21 includes a slender section 22 extending from a rear end 26 (FIG. 5) of an enlarged section 24. The enlarged section 24 includes a front end 25 opposite to the rear end 26. The slender section 22 of the shaft 21 is partially inserted in the bore 14 (FIG. 2) of the shank 11. A socket 36 is formed at the front end 25 of the shaft 21. The socket 36 is a semispherical socket with a depth larger than a half of a diameter 38 (FIG. 5). Thus, a diameter 37 of an open end (not numbered) of the socket 36 is smaller than the diameter 38. There is a boss 39 formed on an internal face of the socket 36. The boss 39 is pointed at a center of the open end of the socket 36 (FIG. 4).

The enlarged section 24 of the shaft 21 includes sides 27 and angles 28 between the front end 25 and the rear end 26. The sides 27 are alternately arranged with the angles 28.

Each of the sides 27 includes a front slant facet 30, a rear slant facet 31 and a horizontal facet 32. The terms “slant” and “horizontal” are given according to an axis of the shaft 21. The front slant facet 30 extends from the front end 25 of the enlarged section 24 of the shaft 21. The rear slant facet 31 extends from the rear end 26 of the enlarged section 24 of the shaft 21. The horizontal facet 32 extends between the front slant facet 30 and the rear slant facet 31.

Each of the angles 28 includes a front slant ridge 33, a rear slant ridge 34 and a horizontal ridges 35. The front slant ridge 33 extends from the front end 25 of the enlarged section 24 of the shaft 21. The front slant ridge 33 of each of the angles 28 extends between the front slant facets 30 of two of the sides 27. The rear slant ridge 34 extends from the rear end 26 of the enlarged section 24 of the shaft 21. The rear slant ridge 34 of each of the angles 28 extends between the rear slant facets 31 of two of the sides 27. The horizontal ridge 35 extends between the front slant ridge 33 and the rear slant ridges 34. The horizontal ridge 35 of each of the angles 28 extends between the horizontal facets 32 of two of the horizontal facets 32.

The front massaging unit 40 includes a ball 41. Preferably, the ball 41 is a solid ball formed with a spherical face 42. However, in another embodiment, the ball 41 can be a hollow ball.

Each of the peripheral massaging unit 50 includes beads 51. Each of the beads 51 includes a central aperture 53 extending between two ends 52 and at least one axial extension 54 extending from one of the ends 52. Each of the beads 51 includes a profile identical to that of the enlarged section 24 of the shaft 21. That is, each of the beads 51 includes sides 55 like the sides 27 and angles 56 like the angles 28.

Each of the sides 55 includes a front slant facet 60, a rear slant facet 61 and a horizontal facet 62. The front slant facet 60 extends from one of the ends 52. The rear slant facet 61 extends from a remaining one of the ends 52. The horizontal facet 62 extends between the front slant facet 60 and the rear slant facet 61.

Each of the angles 56 includes a front slant ridge 63, a rear slant ridge 64 and a horizontal ridge 65. The front slant ridge 63 extends from one of the ends 52. The rear slant ridge 64 extends from a remaining one of the ends 52. The horizontal ridge 65 extends between the front slant ridge 63 and the rear slant ridge 64.

Referring to FIG. 5, the ball 41 is made with a diameter 43 smaller than the diameter 38 of the socket 36 but larger than the diameter 37 of the open end of the socket 36. A front portion of the ball 41 extends from the socket 36 while a rear portion of the ball 41 is inserted in the socket 36. The rear portion of the ball 41 is kept in the socket 36 since the diameter 43 of the ball 41 is larger than the diameter 37 of the open end of the socket 36. The boss 39 is in contact with the rear portion of the ball 41 to provide a gap between the spherical face 42 of the ball 41 and the internal face of the socket 36, thereby rendering the ball 41 smoothly rotatable relative to the enlarged section 24 of the shaft. Thus, the front portion of the ball 41 can massage a user without excessively rubbing the user's skin.

The slender section 22 of the shaft 21 is inserted in the central apertures 53 of the beads 51 before the shaft 21 is connected to the shank 11. The front end of the shank 11 and the rear end 26 of the enlarged section 24 of the shaft 21 together keep the beads 51 on the slender section 22 of the shaft 21. The axial extensions 54 keep the beads 51 at a proper distance from one another, thereby rendering the beads 51 smoothly rotatable relative to one another.

The handle/cap 10 (FIG. 1) is operable to insert the shank 11 in a container (not shown), thereby bringing the applicating unit 20 into contact with cosmetics in the container. Then, the handle/cap 10 is operable to move the applicating unit 20 from the container. Now, the applicating unit 20 carries some of the cosmetics. Then, the hand/cap 10 is operable to bring the applicating unit 20 into contact with a user's skin to applicate some of the cosmetics on the user's skin.

In addition to application of cosmetics on a user's skin, the handle/cap 10 is operable to roll the ball 41 on the user, i.e., massage the user. Alternatively, the handle-cap 10 is operable to roll the beads 51 on the user, i.e., massage the user.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A cosmetic applicator comprising:
a shaft comprising a slender section, an enlarged section formed at an end of the slender section, a socket made in an end of the enlarged section, and a boss extending from an internal face of the socket;
a ball comprising a front portion extending from the socket and a rear portion rotationally inserted in the socket and abutted against the boss; and
at least one bead rotationally extending around the slender section of the shaft.

2. The cosmetic applicator according to claim 1, comprising multiple beads rotationally extending around the slender section of the shaft.

3. The cosmetic applicator according to claim 2, wherein each of the beads comprises an axial extension extending from an end, and the axial extensions of the beads keep the beads at a proper distance from one another to render the beads smoothly rotatable relative to one another.

4. The cosmetic applicator according to claim 1, wherein the bead comprises sides and angles alternately arranged with the sides.

5. The cosmetic applicator according to claim 4, wherein each of the sides comprises a front slant facet extending from an end, a rear slant facet extending from another end, and a horizontal facet extending between the front and rear slant facets.

6. The cosmetic applicator according to claim 4, wherein each of the angles comprises a front slant ridge extending from an end, a rear slant ridge extending from another end, and a horizontal ridge extending between the front and rear slant ridges.

7. The cosmetic applicator according to claim 1, wherein the socket is made with a diameter and a depth larger than a half of the diameter, thereby rendering a diameter of an open end of the socket smaller than the diameter of the socket to keep the rear portion of the ball in the socket.

8. The cosmetic applicator according to claim 1, wherein the enlarged section of the shaft comprises sides and angles alternately arranged with the sides.

9. The cosmetic applicator according to claim 8, wherein each of the sides comprises a front slant facet extending from an end, a rear slant facets extending from another end, and a horizontal facet extending between the front and rear slant facets.

10. The cosmetic applicator according to claim 8, wherein each of the angles comprises a front slant ridge extending from an end, a rear slant ridge extending from another end, and a horizontal ridge extending between the front and rear slant ridges.
